(19) United States
(12) Patent Application Publication
(10) Pub. No.: US 2014/0127017 A1
(43) Pub. Date: May 8, 2014

(54) THE SURFACE STRUCTURE OF WINDMILL ROTORS FOR SPECIAL CIRCUMSTANCES

(71) Applicants: Jorma Virtanen, Las Vegas, NV (US); Kalevi Hauvonen, Espoo (FI)

(72) Inventors: Jorma Virtanen, Las Vegas, NV (US); Kalevi Hauvonen, Espoo (FI)

(73) Assignee: HAFMEX INVEST OY, Espoo (FI)

(21) Appl. No.: 14/130,441

(22) PCT Filed: Jul. 5, 2012
(86) PCT No.: PCT/FI2012/000034

§ 371 Date: Dec. 31, 2013

(30) Foreign Application Priority Data
Jul. 5, 2011 (FI) 20110232

(51) Int. Cl. F03D 11/00; F03D 1/06

(52) U.S. Cl. CPC F03D 11/0025; F03D 1/06
USPC 416/95; 416/241 R

(57) ABSTRACT

The present invention relates to an improvement of windmill rotors—more specifically rotors that have been designed to be used in cold and wet climate, such as northern sea areas. This can be achieved by incorporating an electrically conducting layer on or in the surface of a windmill blade. The same coating can also be used to achieve a stealth property.

A patent application for the BLADE heating system of wind power plant, which technology can be applied for the heating of any surface for the removal of ice and humidity. The same coating can be also being applied for the reduction/elimination of a disturbance caused by windmill for a radar, when used as various concentrations and layers.

### BACKGROUND

In icy conditions, such as northern seas, highlands, and mountain areas, the output of a windmill decreases during winter significantly without working blade heating system. Various heating systems have been tested, but with somewhat bad or a little bit better results. These methods are, for example, blowing warm air onto a blade from inside, integrating heating cables on the surface of the blade, or gluing carbon fiber mat onto a blade.

Fibrous material can be coated with carbon nanotubes so that microscopic and macroscopic conducting fibers will be obtained (Shah T. K., et al., WO 2010/129234) so that the resistance is below 5 Ωm. This kind of material can be used for the heating of airplane wings, and helicopter rotors. Notably, this kind of material is not a nanocomposite unlike the material of the present invention.

The significance of the problem is further amplified, because the production potential of wind power is maximal during winter, when also freezing happens. This will also cause strong mechanical strain for the wind power plant due to the shifting the center of mass of the rotor. Detaching ice blocks are also in land areas significant safety risk. The present method will provide long lasting, carefree, and energy efficient solution that will provide sufficient heating only where it is needed to remove, or prevent the formation, or of ice or crown snow, and maximize the production of energy under icy conditions.

The present invention utilizes carbon nanotube-polysaccharide (CNT-PS) composite that can be further be mixed with epoxy, and used to fabricate thin electrically conducting film by increasing the concentration of the carbon nanotubes, and attaching onto the front surface of the blade, for example, using epoxy, and finally coating with thin, erosion resistant coating, such as nanoepoxy that is sufficiently smooth so that water droplets will not stay on the surface (lotus effect) slowing down freezing (the need for heating will be reduced), and contamination that has also detrimental effect for the production of energy.

Notably, heat conducting and protective coating epoxy resin layers will chemically bind with each other as well as with the structure of the blade (epoxy) so that during the bending of the blades no fractures, cracks, or detachment of the surface elements will occur unlike when different materials (for example, carbon fiber coating) are used.

The structural and coating materials/compounds should be almost the same thermal expansion coefficient as the heating elements of the blade that have been prepared from CNT-PS. Increasing the amount of the carbon nanotubes good electrical conductor will be obtained.

The blades, wings, or rotors of windmills (including different types of wind power plants) will be the main application for the use of the present invention, although other applications are any surfaces that require heating.

This invention can be applied in addition of windmills, for example, various towers, lattice structures, masts, wings and propellers of aircrafts or rotors of helicopters, ship decks, and/or outside surfaces of the hull, roofs, or structures of buildings.

The formation of ice starts from the tip of the blade because of the reduced pressure due greater air velocity, and front edge. Thus, under most circumstances it is sufficient to heat only the ⅓-½ front edge of the blade starting from the tip.

Windmills are detrimental for the function of radars. A large windmill park will give continuously changing obscure background signal in the radar. The disturbance can be so large that the military can limit the placement of windmill parks in the strategic places, such as close to the national border, or high places. However, these places are often best for the production of electricity. The present invention provides a stealth coating, which will eliminate or reduce the disturbance caused for the radars. Compare the claim 14.

Carbon nanotubes (CNTs) have very strong interaction with electromagnetic radiation. The interaction depends on the wave length, but 20 μm thick CNT-paint layer may transmit one millions of the radiation (60 dB) of the wave lengths that are used in radar. The absorbed part may be 99%, and the rest will be reflected. In this context the amount of the reflected radiation is most important. The reflectance may be reduced by various means.

The currently preferred method is the formation of a layered structure, in which the top most layer contains least CNTs, and the lower layer most.

### THE DETAILED DESCRIPTION OF THE PRESENT INVENTION

### The Surface Structure and Composition

This invention utilizes carbon nanotube-polysaccharide (CNT-PS) nanocomposites. Polysaccharide is in this case most advantageously hemicellulose, and especially xylan that is polymer of xylose. Xylan is abundant in many trees, such as birch and beechwood, and straws. Hemicellulose, and especially xylan has proven to be more efficient for the dispersion of carbon nanotubes than cellulose, including nanocellulose. Thus, this invention is different from the earlier heating elements containing carbon nanotubes (Virtanen and Moilanen WO 2008034939).

The resistance of carbon nanotube-polysaccharide nanocomposite is typically under 500 μΩm, and even 5 μΩm, or less than one ten thousands of the resistance of the fibers that have been coated with carbon nanotubes (Shah T. K., et al., WO 2010/129234). It is equally important that the conductivity of CNT-PS nanocomposite does not deteriorate, when it is saturated with epoxy or some other plastic. This is an important improvement as compared with pure carbon nanotubes, or many other carbon nanotube materials, such as Hybtonite that has been proposed to be used for the heating of windmill blades (Virtanen and Hauvonen, FI20100035). The present invention allows the use of considerably smaller amount of material. This is commercially advantageous, because the electrically conducting layer is the most expensive part of the wind mill blade.

The heating element is attached onto the surface already during fabrication as small entities, into which the potential (either AC or DC) is coupled with two separate wires. These wires are often placed inside the front part of the blade on opposite sides so that they are simultaneously isolated/protected from the lightning. Each pair of wires will be attached to their own heating element so that in the case of a damage only the destroyed/damaged element needs to be prepared and the other ones will work normally.

Depending on the size of the blade there will be few or several of these elements. Heating of each element can be controlled separately in order to obtain optimal heating result/melting of the surface ice, and minimize the necessary energy. The heating characteristics of an element (generally carbon nanotube-cellulose-epoxy composite) is adjusted by size (=area, thickness), and conductivity or the amount (% share) of carbon nanotubes in nanocellulose.

The currently favored method of incorporating carbon nanotube-polysaccharide layer into windmill blade is to paint the mold with CNT-PS layer, and attach possible metallic wires with that layer. The wires can be attached with conducting glue, evaporate onto the surface of the paint in the mold, or to deposit electrochemically. For example aluminum can be evaporated or sputtered onto a surface of plastic. In electrochemical deposition two metallic wires will be attached temporarily on the surface of a CNT-PS layer close to each other, for example, by compression. Metal salt solution, for example copper sulfate solution, is placed between the wires so that the solution is in contact only with an anode. When a potential is coupled between the wires, metallic copper will be deposited from the solution onto the surface of a CNT-PS layer in a desired pattern. The fabrication of the blade will be performed in a normal way in a mold. Thus, the CNT-PS layer will stay inside of the blade quite near the surface.

A painted CNT-PS layer may be patterned so that it has several zones that can be heated. If we want to obtain simultaneously stealth property, the whole surface may be painted with CNT-PS mixture, although only some of the zones would be connected with outside potential source. If the stealth property is important, it is advantageous to paint also the heating areas layer by layer, as will be described in more detail in the context of the stealth property. Layered structure is useful also for the heating of the blades. The best heating layer is somewhat (50-500 μm) under the surface. The layer that contains least amount of carbon nanotubes is on the surface.

The surface layer may contain also white particles or particles that have some other color, such as silica, alumina, or titanium oxide so that it can be light gray or have some other color. Carbon nanotube will increase also heat conduction so that the heat that will be generated under the surface will be conducted fast to the surface. The windmill blade will wear several micrometers during one year, and it is not advantageous to place the heatable layer onto the surface. Resistance against the wear can be increased with additional particles, especially silica and alumina. Titanium dioxide makes the surface self-cleaning. Thus, the optimized stealth surface, and heatable surface are surprisingly similar.

CNT-PS nanocomposite will absorb electromagnetic radiation. This property can be utilized for the heating of the blades and also for the stealth property.

If the surface resistance is 374 Ω, all radiation goes through the surface according to the theory, and nothing is reflected back. On the other hand this kind of layer does not absorb very strongly. The next layer has more CNT so that the resistance is smaller and absorption is stronger. This can be continued until the lowest layer has very good conductance, and absorption. Almost no radiation will penetrate to the blade.

The thickness of the layers can be variable so that the top layer is thickest, for example 100 Ωm so that it has a significant total absorption. The layered structure is easy to fabricate, if several paint mixtures have been prepared, having different CNT concentration, typically between 0.1-3%, from dry weight 1-80%. Currently favored paint contains in addition to CNTs also hemicellulose and possibly nanocellulose. Also other typical paint components, such as acrylates may be included. In order to increase absorption metal particles can be added, such as nickel, or silver, and also graphene. Metals can also be deposited electrochemically. Magnetic properties can be improved, if the mixture is radiated by α-, or β-radiation.

In order to increase the durability against the meteorological conditions the top layer may be made as durable as possible. Several polymers may be added into the top layer, because the CNT concentration is small, and conductivity requirement (374 Ω) can be easily obtained. Because the coating of this invention is black, it is possible to add pigments, for example titanium dioxide, into the surface layer. On the other hand a black surface is beneficial, for example, for the removal of ice, when the sun can warm up the black surface under ice so that ice will be detached.

Although the surface structure of this invention is intended for the windmill blades, it is obvious that it can be used for several other applications, such as EMI protected rooms, military vehicles, ships, towers, lattice structures, and air planes.

### Heating Control

The information that is collected from ice sensors on the surface of the blades, and separated ice sensor on the roof the power station, and wind vanes/anemometers, thermometer, humidity meter, and the rotation speed of the rotor will be analyzed using software that has been developed for this purpose so that the computer will calculate the formation and growth velocity of ice at various parts of the blade, and will give information separately to each heating element for the necessary heating power, and duration.

Elements will be further coated with carbon nanoepoxy coating, into which has been mixed according to the need microparticles that add durability, such as silica, alumina, fluoroapatite, silicon carbide, diamond, or superdiamond particles in order to obtain erosion resistance and lotus effect, so that the heating is only needed under extreme conditions. Complete separate lightning protection has special meaning for the protection of elements and the wires.

This heating system and protective coating can be made also into existing blade, but it will require the approval of each blade manufacturer for the assurance of safety and function.

Electricity will be brought to each element with multiple wires that so that wires can be separated for each element. Depending on the manufacturer of the wind turbine it is possible to use either direct or alternating current. The potential will be transmitted either by carbon brush or using wireless energy transfer. Heating power of the elements will be adjusted by changing potential.

The blades can be heated also by electromagnetic radiation. Radiation source can be external, but it can also be inside the blade, for example, microwave radiation source. The wave length should be such that plastic (for example epoxy) does not absorb radiation so that it will reach CNT-PS layer, in which radiation will be absorbed almost completely.

In the axis of the windmill can be a secondary generator in addition to a primary generator for the production of energy for the heating of the blades.

Between or close to the heating elements will be incorporated ice sensors that will give information of progression and velocity of ice formation to a computer, in which the computation is also based on separate ice sensor, anemometers, humidity, and air pressure meters (generally on the roof of machine room).

Heating elements will be protected, when needed, for example, with nanoepoxy (compare claim 3.) in order to obtain erosion resistance and lotus effect. The coating may be applied with a spray gun or a roller.

### EXAMPLE

Multiwalled carbon nanotubes (10 g), cellulose (5 g), and xylan (5 g) were sonicated in one liter of water 30 min. This mixture was used to fabricate paper (100 g/m²). Paper was cut into squares, and electrodes were attached on the opposite sides of these squares.

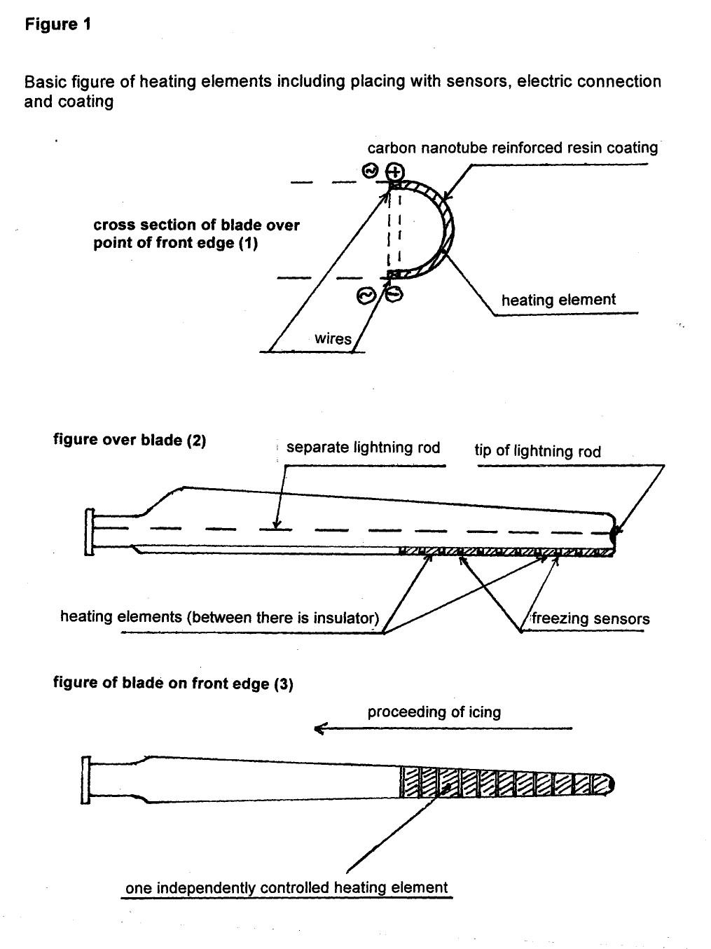

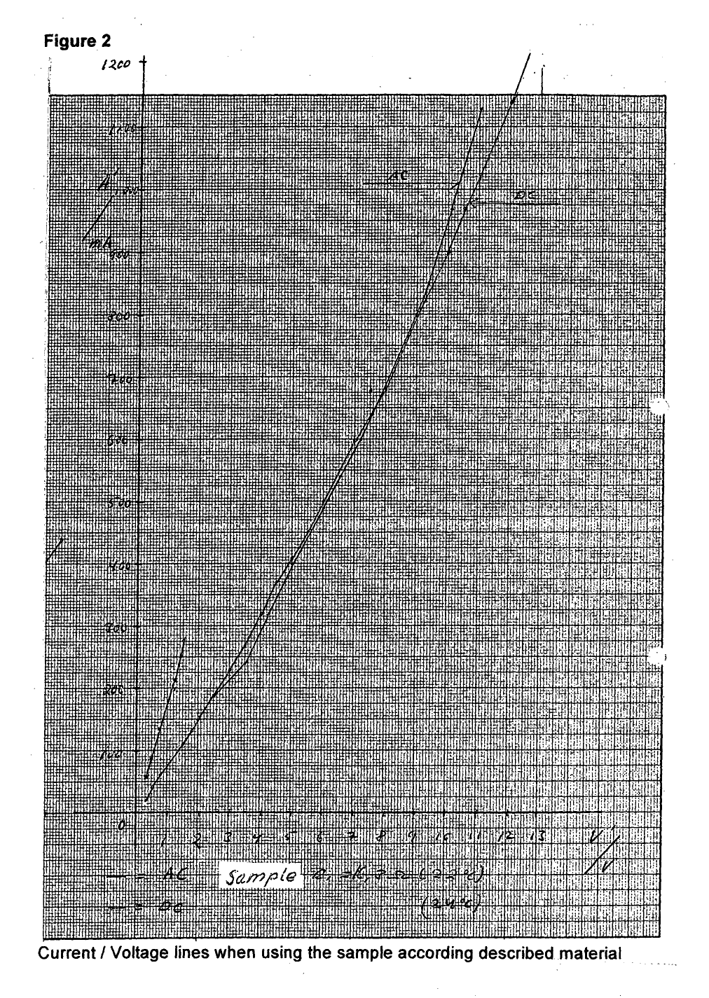

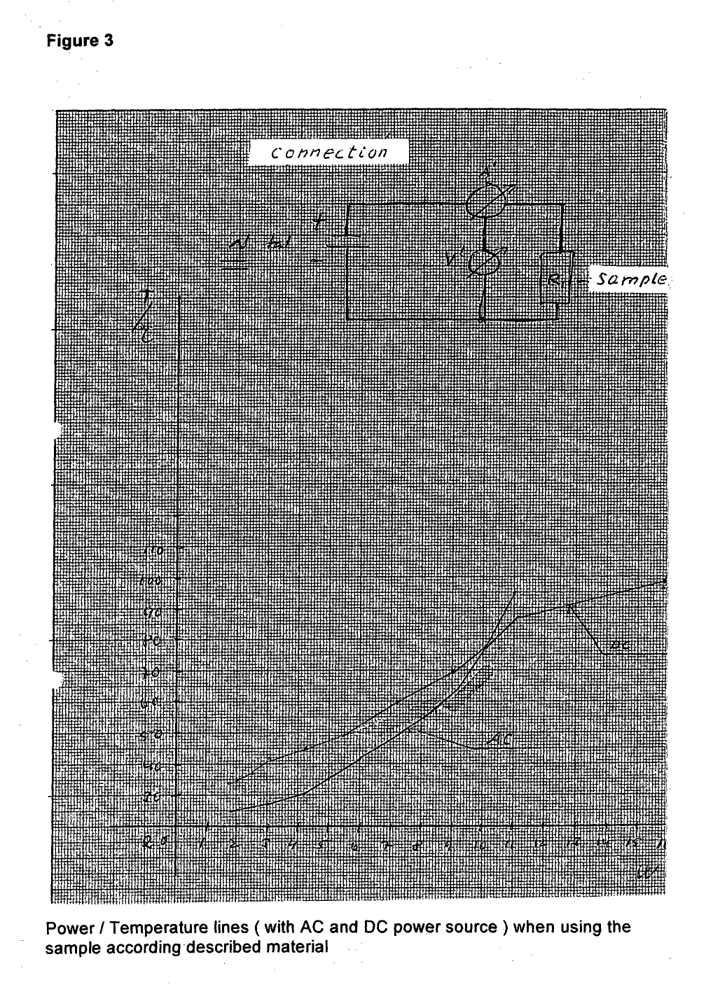

In FIG. 3 are depicted I/V graphs for both AC and DC currents. For example, when 5 V potential was used the temperature of the paper reached fast 37° C. The properties of this material were retained, when it was molded inside epoxy.

1. A coating for windmill blades, known for a) it contains carbon nanotubes, and b) the current for heating is generated by external potential source, or c) the current is generated electromagnetically/electromagnetic induction.

2. A coating of claim 1, in which the said carbon nanotubes are multiwalled carbon nanotubes, and they have been mixed with polysaccharide, such as cellulose or hemicellulose.

3. A coating of claim 1 that contains hard abrasion resistant nano-, or microparticles, such as silica, alumina, fluoroapatite, silicon carbide, diamond, or superdiamond particles.

4. A coating of claim 1 that is used in windmill blade, or in a part of a windmill blade, or in an air plane wing, or in a blade of a helicopter.

5. A coating of claim 1 that is used for heating of a deck structures and/or outer surfaces of a body of a boat or ship.

6. A coating of claim 1 that is used for heating of a roof of a building, or masts.

7. A heating element that has been fabricated using a coating of claim 2, and two wires have been attached with the said heating element, and the wires have been connected with an external potential source that can be direct current or alternating current source.

8. A heating element of claim 7, in which into the attachment site of the said wires, and heating elements has been electrochemically deposited metal, such as copper.

9. A blade of a windmill that contains several heating elements, and each of the said heating element can be heated separately using external control electronics.

10. Heating elements that have been connected to one potential source so that the heating power of the heating elements is adjusted by choosing the thickness of the elements so that at the tip of the blade the resistance of the element is smaller than closer to the base.

11. A heating element of claim 7, in which the resistance is getting smaller stepwise or linearly/smoothly towards the tip of the blade.

12. A windmill blade, in which into the front edge are integrated separate heating elements according to cross-section FIG. (1), and FIGS. (2) and (3) that have been glued, for instance, with epoxy, or spraying coating material of claim 2 on the surface of a mold before fabrication.

13. A windmill blade, in which erosion resistance of the front edge, and heating elements is increased by adding or coating with a coating material of claim 3.

14. A coating material that will absorb radar radio signals, known for the composition that contains carbon nanotubes, and is capable significantly or totally prevention of the reflection the radar signal, eliminating the disturbance for the radar, and allowing the detection of the targets behind the windmill.

15. A windmill blade that has been coated with a coating of claim 1, and that has a microwave source inside.
